(19) United States
(12) Patent Application Publication
(10) Pub. No.: US 2009/0315493 A1
(43) Pub. Date: Dec. 24, 2009

(54) SINGLE-PHASE BRUSHLESS FORWARD AND REVERSE TURN CONTROL CIRCUIT DEVICE

(76) Inventor: Hsia-Yuan HSU, Daya Township (TW)

Correspondence Address: SINORICA, LLC, 2275 Research Blvd., Suite 500, ROCKVILLE, MD, 20850, US

(21) Appl. No.: 12/144,713

(22) Filed: Jun. 24, 2008

(51) Int. Cl. H02P 6/22; H02K 11/00

(52) U.S. Cl. 318/400.09; 318/400.38; 318/400.41

(57) ABSTRACT

A single-phase brushless forward and reverse turn control circuit device is provided, in which a PCB is provided on a stator unit and a rotor unit that are mutually encircled and spaced from each other. On the PCB, a microprocessor unit, a logic unit, a drive unit, and at least one sensor are provided. The sensor is provided in the outer circumference of PCB to sense the variation of a magnetic pole of the rotor unit and then transmit it back to the logic unit and supply it to the drive unit, making the drive unit control the current passing through the coils and then the stator unit generate an opposite magnetic field, the rotor unit thereby smoothly running forward or reversely.

### BACKGROUND OF THE INVENTION

1. Field of the Invention

This invention relates to a single-phase brushless forward and reverse turn control circuit device.

2. Description of the Priort Art

Generally, there are quite various applied single-phase brushless motor, such as a driving motor for DVD and VCD or a heat-dissipation fan for electronic components, the motor being structured with a rotor unit, a stator unit, and a PCB. The stator is fixed onto the PCB around which a sensor is provided. The stator unit stretches at a distance of intervals from the circumference of an shaft hole to a site where several pole pillars are provided, in which a coil wraps around each of the pole pillars and a pole piece projects and stretches from the end of pole pillar. The rotor is circularly hollow, the center of which is formed with a drive shaft that may pass through the shaft hole in the center of rotor unit, and permanent magnets the amount of which is equal to that of pole pillars on the stator unit are provided at the circumference of rotor. The permanent magnets surround and are formed into a hollow ring in the inner circumference of rotor. When the current passes through the coil, the pole piece generates a magnetic field in the Ampere right hand rule, and the coils respectively wrap around the two pole pillars; further, due to the synchronous control of the sensor, the pole pieces are made to be equal in the magnetic field to their opposite permanent magnets that are in the periphery, and in the principle of homo-magnetic repulsion, the rotor is continuously driven to run in a direction for enhancing the efficiency of operation.

The sensor of a conventional DC brushless motor is located in the center of stator and at a front end of the pole piece or below the ordinate linking with a back end; for example, in U.S. Pat. Nos. 3,166,48, 3,43,806, and 343,808, although the sensor is used to detect the magnetic field of permanent magnet for continuously driving the rotor to run in a direction, the DC brushless motor is not made to reverse. Thus, when the DC brushless motor is applied to a fan, the fan cannot reverse and may only blow wind, which cannot drive the fan to rotate reversely for draw the heat out of the indoor and then limit the function. To sum up, it is necessary to effectively solve the problem caused by the conventional single-phase brushless motor.

Consequently, because of the technical defects of described above, the applicant keeps on carving unflaggingly through wholehearted experience and research to develop the present invention, which can effectively improve the defects described above.

### SUMMARY OF THE INVENTION

A single-phase brushless forward and reverse turn control circuit device according to this invention comprises a stator unit and a stator unit. The control circuit device is fixed to the stator unit to control the rotor unit forward and reversely turning. On a PCB, a logic unit, a drive unit, and at least one sensor are provided. The sensor is provided in the outer circumference of PCB to sense the variation of a magnetic pole of the rotor unit and then transmit it back to one terminal of the connected logic unit and supply the drive unit with a positive driving signal or a negative driving signal, and the variation make the drive unit control the current passing through the coils and then the stator unit is made to generate an opposite magnetic field, which makes the rotor unit smoothly run forward or reversely.

### BRIEF DESCRIPTION OF THE DRAWINGS

FIG. 1 is a circuit block diagram of a preferred embodiment of this invention;

FIG. 2 is a top view of the preferred embodiment of this invention;

FIG. 3 is a sectional assembly view of the preferred embodiment of this invention;

FIG. 4 is a circuit block diagram of another embodiment of this invention;

FIG. 5 is a top view of a next embodiment of this invention; and

FIG. 6 is a side view of a further next embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

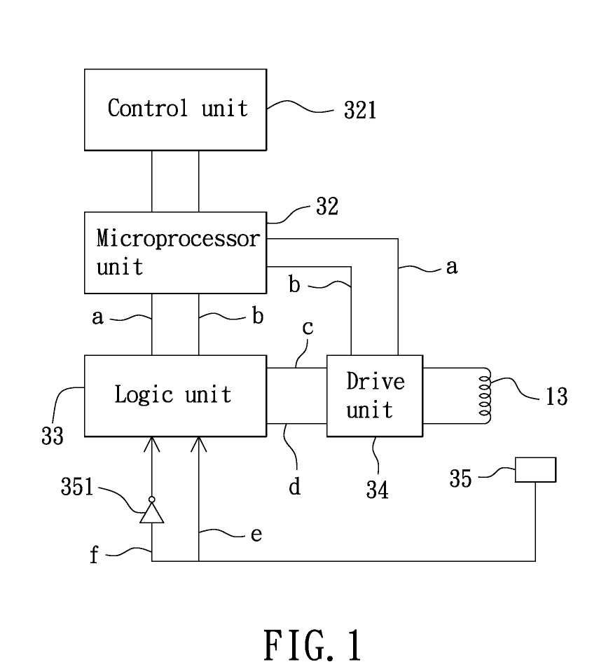

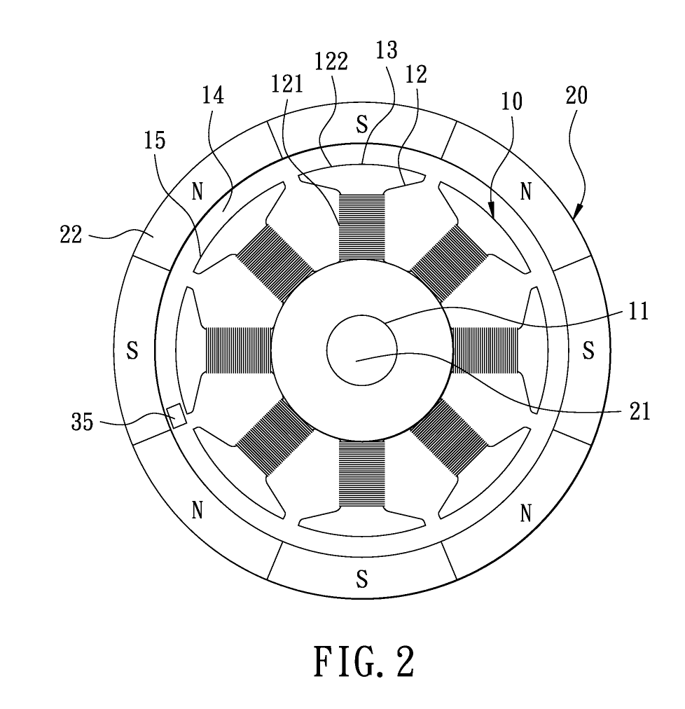

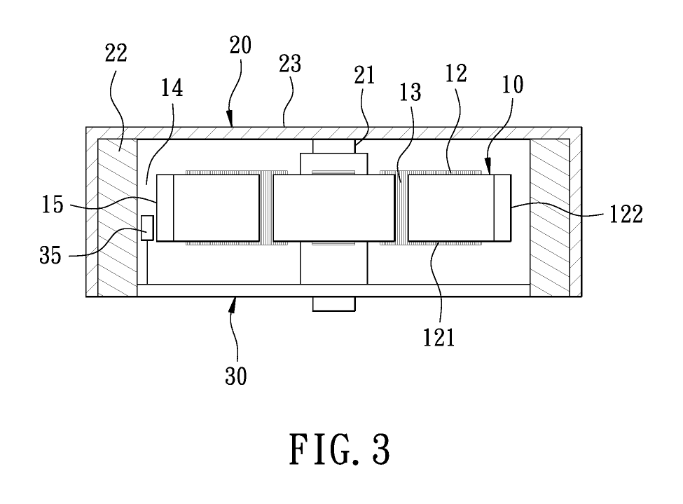

With reference to FIGS. 1 through 3 respectively as a circuit block diagram, a top view, and a sectional assembly view that illustrate a single-phase brushless forward and reverse turn control circuit device according to this invention, in the embodiment, the control circuit device is provided on an outer field single-phase brushless motor. The outer field single-phase brushless motor comprises a stator unit 10 and a rotor unit 20. A shaft hole 11 is formed in the center of stator unit 10. Several magnetic conduction parts 12 stretch from and surround the shaft hole 11 at a distance of intervals. A pole piece 122 is formed stretching from a pole pillar 121 of each of the magnetic conduction parts 12. Several coils 13 wrap around the pole pillar 121 in a radial direction. A drive shaft 21 that may pass through the shaft hole 11 is provided in the center of rotor unit 20. The rotor unit 20 is provided with several permanent magnets 22 the amount of which is corresponding to that of the magnetic conductance parts 12. The permanent magnets 22 are provided around the inner wall of an upper sealed mount 23, and a gap 14 is formed around the outside of permanent magnets 22 and stator unit 10, so pole faces 15 of different magnetic poles of the magnetic conductance parts 12 are respectively opposite to the sides of permanent magnets 22. The control circuit device is fixed to the stator unit 10 to control the rotor unit 20 running forward and reversely, and comprises a PCB 30, a microprocessor unit 32, a logic unit 33, a drive unit 34, and a sensor 35.

The PCB 30 is correspondingly located at a mouth below the mount 23 of the rotor unit 20 below the stator unit 10.

A control unit 321 is connected to one terminal of the microprocessor unit 32 to control the microprocessor unit 32 transmitting a forward turn signal a or a reverse turn signal b.

One terminal of the logic unit 33 is connected to the microprocessor unit 32 to receive the forward turn signal a or the reverse turn signal b and then generate a forward driving signal c or a reverse driving signal d for output.

The drive unit 34 is provided opposite to a side of the coils 13, one terminal of which is connected to the microprocessor unit 32 and the other terminal of which is connected to the logic unit 33 to receive the forward driving signal c or the reverse driving signal d transmitted by the logic unit 33, and thus the control unit 321 is used to control it varying the magnetic conductance part 12 for the magnetic pole, thereby driving the rotor unit 20 to run forward or reversely.

In the embodiment, the sensor 35 is a Hall Effect IC provided around the PCB 30, being opposite to the gap 14 between a side of one of the permanent magnets 22 of the rotor unit 20 and a pole face 15 of the magnetic conductance part 12 to detect a sense area of the magnetic field. One terminal of the sensor 35 is provided with a forward turn feedback signal terminal e and a reverse turn feedback signal terminal f. Further, an inverter 351 is provided on the reverse turn feedback signal terminal f. The forward turn feedback signal terminal e and the reverse turn feedback signal terminal f are connected to the logic unit 33 to detect the variation of magnetic pole of the rotor unit 20.

In order to further make apparent the structural features, applied skill and manners, and expected effects according to this invention, what are applied in this invention are in detail described, and it is thus believed that this invention is thoroughly and concretely apparent, as described below.

Still, with reference to FIGS. 1 through 3, when the single-phase brushless motor is enabled for forward turn, the control unit 321 is used to enable the microprocessor unit 32 to transmit a forward turn signal a to the logic unit 33 for generating and outputting a forward driving signal c to the drive unit 34. The drive unit 34 control the magnetic conductance part 12 varying the magnetic pole by using the control unit 321 to drive the rotor unit 20 to run forward. At this time, the sensor 35 detects the variation of magnetic pole of the rotor unit 20, determines the rotor unit 20 to be the forward turn magnetic pole, and then transmits the signal from the forward turn feedback signal terminal e back to the logic unit 33 and next supply it to the drive unit 34 so that the drive unit 34 may control the current passing through the coils, the magnetic conductance part 12 may generate a relevant magnetic field, and the rotor unit 20 may keep smoothly running forward. When the single-phase brushless motor is enabled for reverse turn, likewise, the control unit 321 is used to enable the microprocessor unit 32 to transmit a reverse turn signal b to the logic unit 33 for generating and outputting a reverse driving signal d to the drive unit 34. The drive unit 34 control the magnetic conductance part 12 varying the magnetic pole by using the control unit 321 to drive the rotor unit 20 to run forward. At this time, the sensor 35 detects the variation of magnetic pole of the rotor unit 20, determines the rotor unit 20 to be the reverse turn magnetic pole, and then transmits the signal from the inverter through the reverse turn feedback signal terminal e back to the logic unit 33 and next supply it to the drive unit 34 so that the drive unit 34 may control the current passing through the coils, the magnetic conductance part 12 may generate a relevant magnetic field, and the rotor unit 20 may keep smoothly running reversely.

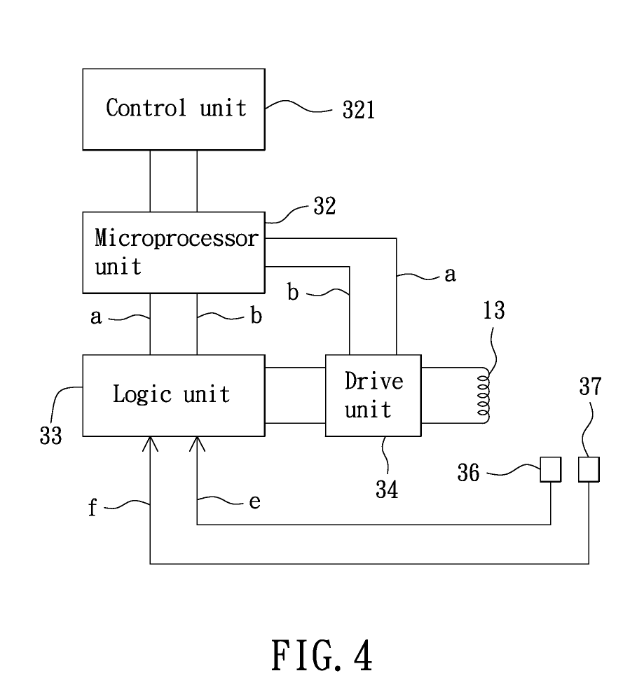

With reference to FIG. 4 as a circuit block diagram of another embodiment of this invention, the structure and function is approximately the same as that in the preferred embodiment of this invention, and what is different is in that two sensors 36 and 37 are provided on the PCB 30. Each sensor 36 and 37 is provided with a positive terminal and a negative terminal. The positive terminal of sensor 36 is connected to a positive terminal of the PCB 30 to form the forward turn feedback signal terminal e; the other sensor 37 is placed in reverse on the PCB 30 to connect its positive terminal to the PCB 30 to form the reverse turn feedback signal terminal f. The forward turn feedback signal terminal e and the reverse turn feedback signal terminal f are connected to the logic unit 33 to detect the variation of magnetic pole of the rotor unit 20.

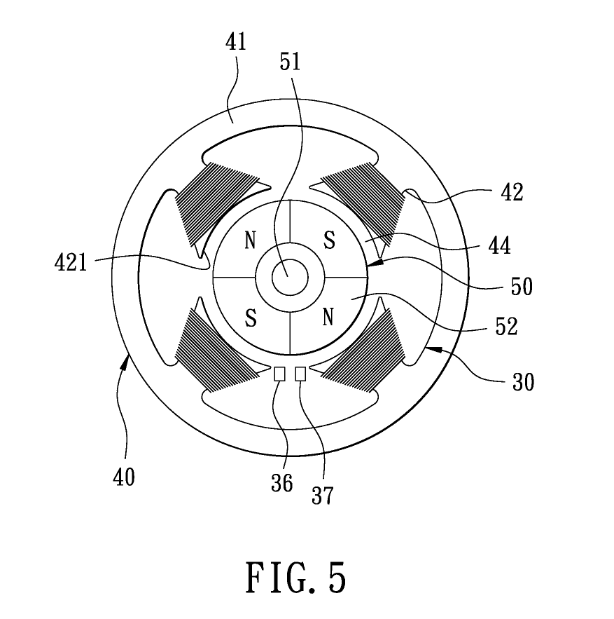

With reference to FIG. 5 as a top view of a next embodiment of this invention, the structure and function is approximately the same as that in the preferred embodiment of this invention, and what is different is in that the control circuit device is arranged on an inner turn single-phase brushless motor. The stator unit 40 surrounds the rotor unit 50. Around a mount 41 of the stator unit 40, four magnetic conductance parts 42 that are provided at a distance of intervals stretch toward the center. Several coils 43 wrap around each magnetic conductance part 42 in a radial direction. A drive shaft 51 is provided in the center of rotor unit 50. Around the drive shaft 51, the permanent magnets 52 are provided, the amount of which is corresponding to that of the magnetic conductance parts 42. A gap 44 is formed around the outside of permanent magnets 52 and stator unit 40, so pole faces 421 of different magnetic poles of the magnetic conductance parts 42 are respectively opposite to the sides of permanent magnets 52. The PCB 30 is located at the mouth below the mount 41 of the stator unit 40 and provided with two sensors 36 and 37. The sensors 36 and 37 are provided in the outer circumference of PCB 30 and opposite the gap between the side of any two nearby permanent magnets 52 and the pole face 421 opposite to the magnetic conductance part 42.

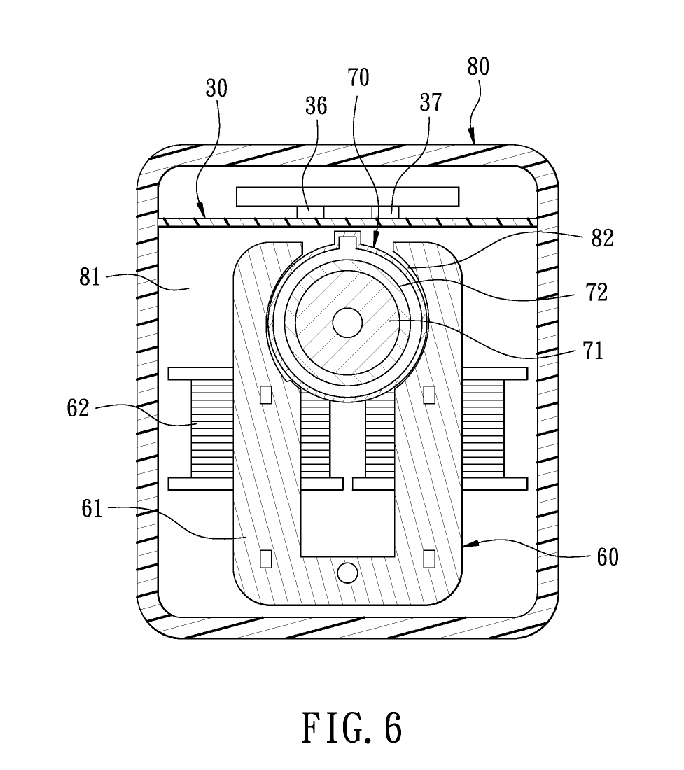

With reference to FIG. 6 as a side view of a next further embodiment of this invention, the structure and function is approximately the same as that in the preferred embodiment of this invention, and what is different is in that the control circuit device is arranged on an inner turn single-phase brushless motor. The stator unit 60 surrounds the rotor unit 70. The rotor unit 70 is provided with a drive shaft 71 that axially passes through a housing 80 inside which a chamber 81 is formed. The drive shaft 71 is covered with an annular magnetic part 72. The stator unit 60 is located in the chamber 81 and provided with many U-shaped silicon steel sheets 61 and coils 62 continuously wrapping around the silicon steel sheets 61. The silicon steel sheets 61 that are kept from each other with gaps 82 surround the rotor unit 70, in which a semicircle is formed in the inner side opposite to the outer ring of rotor unit 70. The PCB 30 is located at an upper end opposite to the chamber 81, and opposite to the openings of the silicon steel sheets 61. The PCB 30 is provided with two sensors 36 and 37 and opposite between the rotor unit 70 and the stator unit 60.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A single-phase brushless forward and reverse turn control circuit device, being structured with a stator unit and a magnetic rotor unit, in which the stator unit comprises a magnetic part wrapped with several coils, the rotor unit and the stator unit are mutually encircled by each other and spaced with a gap, so pole faces of different magnetic poles of the magnetic conductance parts are respectively opposite to the side of rotor unit, and the control circuit device is fixed to the stator unit to control the rotor unit running forward and reversely, and mainly comprising:
a PCB opposite to one side of the stator unit;
a microprocessor unit provided on the PCB, one terminal of which is connected to a control unit to control the microprocessor unit transmitting a forward turn signal or a reverse turn signal;
a logic unit provided on the PCB, one terminal of which is connected to the microprocessor unit to receive the forward turn signal or the reverse turn signal and then generate a forward driving signal or a reverse driving signal for output;
a drive unit being provided on the PCB and relevantly opposite to a side of the coil of the stator unit, one terminal of which is connected to the microprocessor unit and the other terminal of which is connected to the logic unit to receive the forward driving signal or reverse driving signal that is transmitted by the logic unit, and thus the control unit being used to control it varying the magnetic conductance part for the magnetic pole, thereby driving the rotor unit to run forward or reversely; and
a sensor being provided in the outer circumference of PCB and opposite to a gap between the rotor unit and the stator unit, one terminal of which is provided with a forward turn feedback signal terminal and a reverse turn feedback signal terminal to connect the logic unit to sense the variation of a magnetic pole of the rotor unit and then transmit it back to the logic unit and supply it to the drive unit, making the drive unit control the current passing through the coils and then the stator unit generate an opposite magnetic field, the rotor unit thereby smoothly running forward or reversely.

2. The single-phase brushless forward and reverse turn control circuit device according to claim 1, wherein the sensor is a Hall Effect IC.

3. The single-phase brushless forward and reverse turn control circuit device according to claim 1, wherein a sensor is provided on the PCB that is opposite to a pole face between the rotor unit and the stator unit, and one terminal of the sensor is provided with the forward turn feedback signal terminal and the reverse turn feedback signal terminal provided with an inverter.

4. The single-phase brushless forward and reverse turn control circuit device according to claim 1, wherein two sensors are provided on the PCB that is opposite to the pole face between the rotor unit and the stator unit, each of the sensors is provided with a positive terminal and a negative terminal, the positive terminal of one of the sensors is connected to a positive terminal of the PCB to form the forward turn feedback signal terminal, the other sensor is placed in reverse on the PCB to connect its positive terminal to the negative terminal of PCB to form the reverse turn feedback signal terminal, and the forward turn feedback signal terminal and the reverse turn feedback signal terminal are connected to the logic unit.

5. The single-phase brushless forward and reverse turn control circuit device according to claim 1, wherein the control circuit device is provided in an outer field single-phase brushless motor, the rotor unit surrounds the stator unit, a shaft hole is formed in the center of stator unit, several magnetic conduction parts stretch from and surround the shaft hole at a distance of intervals, several coils wrap around each magnetic conductance part in a radial direction, a drive shaft that may pass through the shaft hole is provided in the center of rotor unit, the rotor unit is provided with several permanent magnets the amount of which is corresponding to that of the magnetic conductance parts, the permanent magnets are provided at the wall of an upper sealed mount, and a gap is formed between the permanent magnets and the outer circumference of stator unit, so the pole faces of different magnetic poles of the magnetic conductance parts are respectively opposite to the sides of permanent magnets.

6. The single-phase brushless forward and reverse turn control circuit device according to claim 1, wherein the control circuit device is provided in an inner turn single-phase brushless motor, the stator unit surrounds the rotor unit, around a mount of the stator unit, four magnetic conductance parts that are provided at a distance of intervals stretch toward the center, several coils wrap around each magnetic conductance part in a radial direction, a drive shaft is provided in the center of rotor unit, around the drive shaft, the permanent magnets are provided, the amount of which is corresponding to that of the magnetic conductance parts, and a gap is formed between the permanent magnets and the outer circumference of stator unit, so the pole faces of different magnetic poles of the magnetic conductance parts are respectively opposite to the sides of permanent magnets.

7. The single-phase brushless forward and reverse turn control circuit device according to claim 1, wherein the control circuit device is provided in an inner turn single-phase brushless motor, the stator unit surrounds the rotor unit, the rotor unit is provided with a drive shaft that axially passes through a housing inside which a chamber is formed, the drive shaft is covered with an annular magnetic part, the stator unit is located in the chamber and provided with many U-shaped silicon steel sheets and coils continuously wrapping around the silicon steel sheets, and the silicon steel sheets that are kept from each other with gaps surround the rotor unit, in which a semicircle is formed in the inner side opposite to the outer ring of rotor unit.
